(19) United States
(12) Patent Application Publication
(10) Pub. No.: US 2026/0366610 A1
(43) Pub. Date: Nov. 19, 2026

(54) PLANETARY TRANSMISSION WITH AT LEAST ONE WEAR-REDUCING FORCE-LOCKINGLY/FRICTIONALLY MOUNTED SHAFT, AND METHOD AND USE

(71) Applicant: Flender GmbH, 46395 Bocholt (DE)

(72) Inventors: Thorsten Fingerle, Bocholt (DE); CHRISTOPH LOHMANN, Bocholt (DE); VOLKER LENSING, Bocholt (DE); RALF KLEINE-BROCKHOFF, Bocholt (DE)

(73) Assignee: Flender GmbH, 46395 Bocholt (DE)

(21) Appl. No.: 19/103,158

(22) PCT Filed: Sep. 18, 2023
(86) PCT No.: PCT/EP2023/075643

§ 371 Date: Feb. 11, 2025

(30) Foreign Application Priority Data
Sep. 16, 2022 (EP) 22196090.9

(51) Int. Cl. F16H 57/021; F03D 15/10; F16H 57/02; F16H 57/023

(52) U.S. Cl. CPC F16H 57/021; F03D 15/101; F16H 57/023; F05B 2260/40311; F16H 2057/02078

(57) ABSTRACT

A planetary transmission includes a shaft, and a shaft receptacle designed to fixedly mount the shaft in an axial portion in the shaft receptacle. The shaft is mounted in the shaft receptacle via a structured surface portion in a force-locking or frictional manner so as to restrain the shaft against displacement in an axial direction. The shaft and the shaft receptacle are direct contact partners.

### TECHNICAL FIELD

The present invention relates to a planetary transmission, comprising at least one shaft and at least one shaft receptacle for the mounting of the shaft, wherein the shaft is (axially) fixedly mounted in at least one axial portion in the shaft receptacle, optionally in two axial portions, in particular is in each case mounted at a free end of the shaft, wherein the shaft is provided with a wear-reducing surface, in particular with the planetary transmission or comprising at least one planetary transmission stage. Furthermore, the present invention also relates to wear-reducing shafts with at least one structured surface for such an industrial transmission.

DE 10 2015 007 470 A1 describes various types of laser surface structuring and texturing for toothings. In particular, a transverse and pressure bracing and longitudinal pressure bracing are described. Classic torque-transmitting shaft-hub connections are mentioned as one application case.

WO 2005/015057 A1 describes, for planetary transmissions, a press fit or a force-locking connection, via which the planetary shafts sit in the planet carrier,

### BACKGROUND OF THE INVENTION

High output densities in transmissions such as, for example, planetary transmissions, industrial transmissions, wind turbine transmissions or wind turbine drive trains, require sufficient stiffnesses, in particular also of the torque-conducting components, and corresponding fastenings and fixings. Especially in planetary transmissions, shaft fixings on planet carriers with multiple planets tend to perform disadvantageous micro-movements under load in particular when sufficient compression is undershot, this potentially causing noticeably increased wear. It has now been recognized that such local micro-movements (and thus associated wear) become increasingly more probable as a function of an output density-induced loss of stiffness in surrounding components. There is therefore a high level of interest, in particular in high power range industrial transmissions designed for long operating periods, in being able to ideally completely suppress these micro-movements.

To date, shaft fixings in this regard are implemented by extending the fixing length (in particular in the case of associated, more disadvantageous installation space requirements) and/or by increasing the fit and thus increasing compression in the contact region between shaft and shaft receptacle (in particular the bore). However, the regions about the shaft fixings can be elastically deformed as a function of the load, in particular also in a planet carrier. In particular in the case of thin-walled components, this has a potentially very negative effect in particular also on adjacent bearing seats. A self-reinforcing negative effect resulting from a press fit which is increasingly becoming loose, or enlarged, is also disadvantageous, which as a consequence leads to even greater displacements or relative movements in the contact region, as a result of which more material or abrasion is in turn generated by frictional wear. Particles released due to wear potentially lead to severe or even greater secondary damage, for example due to abrasion, as a result of which the service life of the entire transmission is potentially very greatly reduced.

Accordingly, there is a high level of interest in minimizing the wear in particular in the context of the particularities of industrial transmissions described here, especially also in planetary transmissions, in particular at comparatively high or dynamic loads such as, for example, in drive trains of wind turbines.

### SUMMARY OF THE INVENTION

It is the object of the present invention to demonstrate measures by means of which a noticeable reduction in wear at an interface between shaft and shaft receptacle in planetary transmissions can be ensured, in particular while minimizing any resulting design disadvantages regarding the entire design of the transmission, In particular, it is also the object to provide an axially fixed mounting at the shaft/shaft receptacle interface in planetary transmissions for a high-load-bearing transmission of torque or, if required, for a particularly high surface pressure, while being usable in as many variants as possible in different types of transmissions.

The object is achieved by a planetary transmission having the features of claim 1, by a shaft produced according to the features of the corresponding further independent method claim, and by corresponding uses according to the features of the corresponding further independent use claim. Preferred refinements are specified in the dependent claims and in the description below, which may individually or in combination with one another represent an aspect of the invention. If a feature is described in combination with another feature, this is used only for simplified description of the invention and is in no way to mean that this feature cannot also be a refinement of the invention without the other feature.

One aspect of the invention relates to a particularly wear-reducing shaft for the mounting of at least one transmission component, e.g. planetary gears in a planetary transmission. In this respect, a planetary transmission is provided, comprising at least one shaft and at least one shaft receptacle for the fixed or axially fixed mounting of the shaft, in particular shaft of a planetary gear, wherein the shaft is mounted in at least one axial portion in the shaft receptacle; wherein the shaft is mounted in the shaft receptacle by means of at least one structured surface portion force-lockingly/frictionally against axial displacement, the shaft and the shaft receptacle being direct contact partners.

According to the invention, it is therefore proposed to provide a surface structuring for a shaft fixing, which is structured in such a way that a sufficient purely force-locking axial fixing can be ensured, when there is direct contact between shaft and shaft receptacle. This also enables a slimmer design concept, e.g. in respect of any axial securing elements that are now no longer necessary. In other words, the surface structuring measure according to the invention also enables a slim and advantageously realizable transmission design, in particular even in the high power range, with a minimized number of components in or for the shaft seat. A fixed or axially fixed mounting should be understood as meaning in particular a mounting or fastening in which no significant torques can be transmitted or in which a defined axial positioning of the contact partners is of primary importance. This involves axial fixing without a torque transmission function or without a substantial torque transmission function.

The measure according to the invention also leads to an improvement in the mountability (in particular without even greater expansion of the bore/shaft receptacle than previously required in many applications), especially since the fits to be provided do not increase even more strongly (do not become greater). In contrast to structuring of the shaft bore, it has also proven to be advantageous or technically more expedient in many applications, especially with regard to the manufacturing process, to use the shaft, which is easier to handle, to provide a surface structuring. The structuring can be realized on different materials and material combinations, and therefore the present invention can be realized independently of any desired changes to the material partners (material pairings). Optionally, a/the anti-twist securing means can also be dispensed with, in particular also for cost reasons. However, the reference of the present invention to the shaft as a structured component does not exclude the possibility that further component parts/components are provided with structured surfaces.

Targeted (laser) structuring in at least one axial portion of the shaft in the contact region with the shaft receptacle (e.g. planet carrier) allows an Increase in the coefficient of friction (or coefficient of static friction), particularly in the case of a shaft/bore fit, as a result of which local micro-movements and thus uncontrolled frictional wear can be effectively counteracted. Such an increase in the coefficient of friction also enables the overall stiffness to be Increased, in particular in an assembly comprising planet carriers and planetary shafts, and therefore deformation of the carrier assembly under load can be noticeably reduced. The surface structure described here can be generated or provided either over the entire circumference or in a specifically optimized manner at local critical transition regions of the shaft in the corresponding axial portion. For example, a linear density and/or alignment of the structure and/or intensity and shape of the structure is individualized. By means of (laser) structuring, an insoluble, martensitically hard surface structure can be created, which only insignificantly affects or does not affect the tolerances to be observed of the shaft (for example, tolerances previously achieved by precision machining), because a shaping in the sense of a noticeable geometric change in the surface contour is not carried out. For example, a/the laser structuring is provided over the entire shaft circumference and/or is divided into zones axially in the load and impeding direction and is provided to be correspondingly stronger, weaker, impeding or so as to have a reduced action in the joining direction.

It has been shown that the structuring according to the invention of the shaft surface can also be advantageously combined with further, in particular upstream production/manufacturing steps, in particular even for serial manufacturing of comparatively large piece numbers; for example, for laser structuring of the shaft surfaces (contacting surface regions of the shaft) and also for application of plain bearing layers (e.g. on coated plain bearing shaft portions of planetary shafts), use can be at least partially made of the same installations and machines (in particular laser welding installations for laser overlay welding in combination with laser structuring). This also allows the production process of the respective shaft to be optimized in terms of time and cost, for example also by noticeably reducing/avoiding logistics/transport costs. Insofar as structuring is mentioned here, reference is made primarily to laser structuring; nevertheless, the concept according to the invention can also be realized with other/alternative types of structuring. In this respect, the invention also comprises alternative partial/demand-oriented structures, which are introduced into the respective surface in an optimized manner with regard to the type/form of load.

In principle, it is possible to structure both the shaft and the shaft receptacle in accordance with the measures described here. Preferably, the structuring is provided at least on the shaft and optionally additionally in the shaft receptacle; particularly advantageously, the shaft is provided consisting of significantly harder material than the shaft receptacle; In this case, the axially fixed connection can also have a particularly effective action if the shaft receptacle is not structured (further outlay can also be saved in this respect). The structure embossed into the shaft surface can be anchored particularly effectively in the shaft receptacle (in particular also in the sense of being impressed into a relatively softer contact partner). The shaft can be either cylindrical or, for example, also conical in the respective contact region.

The present invention not least enables targeted local optimization of mechanically comparatively heavily loaded interfaces, in particular by providing a comparatively highly individualizable contact surface for force locking (static friction) in at least one axial portion by (laser) structuring. Such a shaft fixing also affords numerous other indirect advantages, such as a comparatively slim/cost-effective manufacturing approach regarding the use of lasers, especially over a multi-stage production process, also comprising laser (overlay) welding. Particularly advantageous application regions also follow, for example, for wind power generator transmissions with plain bearings, for planetary gear transmissions and numerous other industrial applications.

Advantageously, the fixed or axially fixed mounting can already be realized by (laser) structuring of only one of the contact partners; the force-lockingly acting surface structure also provides great advantages, especially on the shaft, in respect of outlay on manufacturing and installation. It has also been shown, especially in the case of planetary transmissions, that the weaker and therefore more wear-prone component (or a particularly weak component) is usually the shaft receptacle (or a corresponding planet carrier bore), which can only be upgraded in terms of wear protection in a complicated way because of the size of the shaft receptacles or the planet carrier and the composition thereof (e.g. material composition, for example relatively soft material, for example cast material). In this respect, too, the invention makes it possible to overcome previous difficulties.

In other words, the invention is also based on the concept of providing a shaft which can ensure wear protection in the region of a/the shaft receptacle, e.g. a (planet) carrier bore in an individualizable and application-specific manner, namely by specifying a certain surface structure, for example also In connection with a certain material hardness and/or normal force or fit. The shaft improves the wear resistance, especially in the region of at least one fixing point of the shaft, specifically substantially independently of the basic material. The shaft can also consist of one or more layers of different materials. Hard layers afford advantageously pronounced wear protection, while soft layers can primarily also ensure elastic deformation, especially without flowing in the process. In this respect, a correspondingly selected combination of materials can also enable advantageous functional Integration into just one single machine element (multiple function). A person skilled in the art can determine individually for the respective application, in particular depending on the materials of shaft and receptacle, which hardness ranges should in each case be considered relatively hard and relatively soft.

The shaft can effectively force-lockingly/statically frictionally counteract an axial displacement out of the shaft bore (or a corresponding axial relative movement) and uncontrolled frictional wear (optionally, a material-locking fixing can additionally also be provided, in the context of an additional securing feature, without this securing feature having to provide a high force flux) on two axial portions bylowing to corresponding (laser) structuring. In at least one axial portion, even a slightly conical geometry can optionally also be selected. As a result of the (laser) structuring, a comparatively hard surface structure can also be achieved here which is insoluble (is not deformable back to its original state) and which does not adversely affect, or if at all only insignificantly adversely affects, the tolerances of the shaft previously achieved usually by precision machining (or the tolerances required for a respective application).

In this case, one of the structuring types described here can optionally be divided into zones over the circumference and/or axially in the direction of load and movement and can be designed or configured to be correspondingly stronger, weaker, impeding or so as to have a reduced action in the joining direction. Within these zones, in particular, a linear density, the direction of the structure and/or the intensity and shape of the (laser) structure can be adapted to specific characteristics and requirements of the respective shaft contact. In this respect, too, the present invention provides a comparatively high degree of variability. In this case, the shaft may also be thickened or tapered on one side, In particular to compensate for position tolerances of the shaft receptacles (or carrier bores) by orientation during the installation. This also leads not least to improved load-bearing capacities. In this respect, the present invention also provides a technically easily realizable solution for different installation situations. The shaft receptacle or carrier bore can optionally be cylindrically straight, conically or spherically shaped or formed optionally also with grooves for axial and/or tangential securing. The shaft receptacle or a shaft seat which can optionally also be structured can preferably be cylindrical or else conical, helical or wavy, in particular also with regard to a design which is self-locking against rotation. Materials with similar properties can also be combined with one another (e.g. in terms of microstructure, hardness). The present Invention can be implemented both for new products and in conjunction with service applications.

It has been shown that the present invention can also ensure the following advantages: in comparison to previous pairings without a (laser) structured surface optimized for force-locking, there is no uncontrolled initial conditioning of the shaft contact. This also results in noticeably less input of material into the oil and transmission. In particular, it facilitates the avoidance of strain-hardened particles that could damage the bearings or toothing. The improved fixing, for example, also reduces radial and axial deformations of the planet carrier, especially in a planetary transmission, which in turn reduces the micro movement in the shaft contact and thus contributes to the reduction in frictional wear. Furthermore, structural components can now be more easily dimensioned so as to be optimized in terms of weight. The Increase in stiffness achieved improves the load-bearing behavior of the assembly, with in particular a more efficient dimensioning of the toothing and bearing also being possible. These measures are also directly associated with increases in output density.

In particular, “force-lockingly” and in the narrower sense “frictional” or “statically frictional” (with reference to connections without a permissible relative movement) should be understood as meaning here a fixed connection without the need for specific shaping or geometric unevennesses, such as edges or shoulders or noticeable scores or serrated profiles or the like, wherein this effect can be realized here in particular also by reference to completely plane/flat surfaces (in particular cylindrical or conical shell surfaces), on which therefore no shoulders or edges in a geometrical sense have to be present, but which can ensure adhesion/fixation according to a static coefficient of friction defined by the structuring. The force-locking can be ensured depending on a certain normal force acting on the contact surfaces (whereas in the case of a positive locking such a normal force is/would not necessarily be required). The present disclosure should also be understood in such a way that, with reference to “force-locking”, the corresponding surface is provided or designed or configured for a substantially force-locking connection. In contrast, “positive-locking” would be understood as meaning a connection which is substantially based on a positive lock in the sense of a mechanical toothing, i.e. is based on geometric conditions of the respective surface, which, simply because of the shaping alone, also cause the contact partners to anchor or adhere to each other if no normal force is applied.

The term “industrial transmission” should generally be understood as meaning a transmission device for industrial applications, for example in the form of a (bevel) spur gear or planetary transmission or screw extruder transmission or ship transmission or generator transmission or digger transmission or mill transmission or running gear transmission, in each case having at least one transmission stage. For example, an industrial transmission described here comprises at least one planetary transmission stage. Insofar as reference is made to a shaft receptacle in accordance with the present disclosure with regard to the Industrial transmission, in the case of planet carriers this also applies in particular to shaft bores in the planet carrier. The present disclosure, however, generally refers to shaft receptacles of any configuration, irrespective of the type of transmission.

A fixed or axially fixed mounting should be understood in particular as meaning a mounting/fastening in which no appreciable torques should be transmitted or in which an axially fixed positioning of the contact partners is of primary importance; the shaft is arranged in a predefined axial target position in the shaft receptacle and defines, for example, an axis of rotation for a planetary gear guided by means of a planet carrier. Accordingly, the term “axially fixed” may also comprise a torsionally fixed arrangement; according to the present disclosure, the term “axially fixed” is used, since the task of minimizing axial relative movements is predominantly to be overcome for the applications envisaged. Nevertheless, the advantages described here in conjunction with the axially fixed arrangement can also be further characterized by an Improved torsional strength associated with the measures according to the invention.

Personified terms, unless worded in the neutral herein, may refer to all sexes in the context of the present disclosure. Any English expressions or abbreviations used here are in each case technical expressions customary in the respective sector and are familiar to a person skilled in the art in English. Any German terms which are used/may be used synonymously thereto or otherwise may be stated in (brackets) for the sake of completeness here, or vice versa.

Individual exemplary embodiments will be discussed more specifically below; the combinations of features described in each case below can be combined with one another unless this is explicitly negated here.

According to one exemplary embodiment, the shaft, in at least one cylindrical surface portion, has a force-lockingly acting, structured outer shell surface portion, which comes to bear purely force-lockingly in a fixed/axially fixed manner in the shaft receptacle, In particular in the manner of a fit, in such a way that a/the normal force acting in the corresponding surface portion between shaft and shaft receptacle (subcritically) reduces or suppresses/prevents an axial relative movement. This not least also promotes a very safe and robust long-term behavior, not least also owing to the reducible number of components, e.g. in conjunction with an axial securing means.

According to one exemplary embodiment, the structured surface for force-locking support in the axial direction is provided in at least one axial portion with a force-lockingly acting, structured surface structure having an increased coefficient of static friction in comparison to the other non-processed surface portions of the shaft or the shaft receptacle, in particular a coefficient of static friction of at least 0.5 (especially for metallic material pairings/contact partners, in the case of a dry guideline value). This not least also enables a cost/outlay-optimized design, especially in the event that different axial portions of the shaft are intended to fulfill different functions (e.g. even a plain bearing function).

According to one exemplary embodiment, the at least one laser-structured surface portion varies over the circumference or in the circumferential direction (in particular in a geometrical respect).

According to one exemplary embodiment, the at least one (laser) structured surface portion is configured fully circumferentially in the corresponding axial portion on the shell surface of the shaft, in particular at one of the ends of the shaft, for example having an axial length in the range of 30 to 70% of the thickness of the shaft. This not least also favors a robust design with regard to different types of force application, i.e. not only in the axial direction, but also with regard to the maximum possible frictional anchoring on the available contact surface. This can also promote the distribution of force over as wide an area as possible.

According to one exemplary embodiment, the structured, in particular laser-structured surface is provided on at least one side of a gear mounted around the shaft.

According to one exemplary embodiment, the laser-structured surface is formed on both sides of a gear (in particular planetary gear) mounted around the shaft, or of a bearing surface provided for this purpose. Laser structuring formed on both sides, particularly in the region of the two ends of the shaft, can also promote a particularly precise orientation and stable mounting of the shaft, even with a very short overall length or with only a small amount of space available.

According to one exemplary embodiment, a/the structuring of the structured surface portion is interrupted in individual segments of the structured surface portion.

According to one exemplary embodiment, the shaft is designed to be relatively harder at least in the radially outer region of the contacting surface or in the respective axial portion or consists of a relatively harder material (or material/material combination) than the shaft receptacle at least in the corresponding contact region. This can also advantageously bring about an anchoring action of the structure/laser structure on the surface of the shaft receptacle, in particular in the event of large normal forces; this configuration of the degrees of hardness also affords advantages in particular when a certain type of post-processing or configuration of the shaft receptacle is not desired, is not possible, or is also intended to be entirely dispensable.

According to one exemplary embodiment, within at least one surface portion of the shaft, a linear density and/or direction of the structure and/or an intensity and shape of the structure is individualized, in particular in such a way that (depending on the installation situation and in particular also depending on the normal force or depending on the type of a/the fit of the contact partners) a coefficient of static friction of at least 0.5 in the axial direction over the structured surface portion is (at least partially) ensured. The present invention, with great flexibility/variability, permits individualization at least with regard to these parameters in a comparatively simple manner, especially also when integrating a (laser) structuring process into a sequence of further production steps.

According to one exemplary embodiment, the industrial transmission is designed as a planetary transmission, wherein a/the shaft receptacle is provided in a planet carrier of the planetary transmission, In particular in the form of a planet carrier bore, and wherein the shaft as a planetary shaft is arranged on the planet carrier in a positive-locking manner against axial relative movement or acts in a wear-reducing manner there. When the shafts described here are used in planetary transmissions, particularly those with highly loaded drive trains, the advantages described here are particularly noticeable. Depending on the number of planet gears, the number of shafts can be individually adapted. The design described here of the shaft(s) can also be implemented at other locations (installation points) within the planetary transmission.

For example, the planetary transmission is installed in a drive train of a wind turbine or is configured for this purpose.

According to one exemplary embodiment, the respective shaft is mounted (in an axially fixed manner) in two axial portions in the shaft receptacle, optionally in each case with cylindrical or conical contact surfaces, wherein the laser-structured surface in the two axial portions optionally has the same or a different configuration. Depending on the desired type of installation or fit, the structure/laser structure described here can also be provided on an inclined surface, e.g. with conical geometry. This also increases variability and also promotes implementation with potentially further machine elements that may be installed.

Alternatively, the respective shaft is mounted in a fixed or axially fixed manner in two axial portions in the shaft receptacle, namely on the one hand with a cylindrical and on the other hand with a conical contact surface, wherein the laser-structured surface in the two axial portions has a different configuration, in particular depending on a type of installation and/or a cylindrical or conical geometry of the corresponding shaft portion. This also enables even greater individualization and more specific consideration of special features, such as a specific installation situation or interaction with other machine elements.

One aspect furthermore relates to a production method, in particular for the integration in terms of manufacturing process of the laser structuring method step(s) into further production steps of a/the shaft. The aforementioned object is also achieved in this respect by a method according to the corresponding further independent method claim, namely by a method for producing a wear-reducing shaft for use in an industrial transmission in at least one shaft receptacle for the fixed or axially fixed mounting of the shaft in the shaft receptacle, in particular for use on a planet carrier of a planetary transmission, wherein a laser-structured surface which is designed for force-locking support in the shaft receptacle against axial displacement is introduced in at least one axial surface portion (axial portion) of the shaft, in particular by means of a laser welding installation which is furthermore also designed for laser welding/laser overlay welding, in particular in combination with the formation of at least one plain bearing portion in a further axial portion of the shaft, in particular a shaft previously described further above. This results in the advantages mentioned above, in particular also with regard to minimized cost/manufacturing outlay and greater possibilities for variation or also with regard to the dispensability of any further machine elements.

According to one embodiment, a substantially force-lockingly acting surface is introduced in at least one surface portion of the shaft by at least one of the following laser-structuring measures, the laser-structured surface being generated preferably depending on at least one predefined/predefinable specific elevation parameter and/or density parameter, in particular in a wavy or serpentine structure or in an imbricated structure (in each case symmetrically or asymmetrically): laser structuring of a first axial surface portion, in particular over the full surface area of the shaft, laser structuring of at least two axial surface portions, in particular with variation in the orientation of the structure in at least two spatial directions, laser structuring with an axially and/or rotationally moving shaft, laser structuring with a fixed shaft. These variation options not least also allow a high degree of individualizability and a comparatively flexible coordination with possible upstream and/or downstream process steps, especially on the same manufacturing line/plant. In this case, the laser structuring can also be carried out subsequently to laser overlay welding and/or subsequently to the formation of at least one plain bearing portion, in particular in/by means of the same laser installation or in/by means of the same manufacturing line comprising at least one laser installation.

Preferably, a first structure/laser structure is introduced in a first axial portion and a second structure/laser structure is introduced in a second axial portion, wherein the first and second structures/laser structures have different parameters or have been introduced with laser parameters differing from one another. This enables the respective force-locking contact to be optimized, e.g. with regard to the amount or type of prevailing forces/moments/loads, This not least also favors an individually optimized shaft seat, especially for planet carriers.

The abovementioned object is also achieved by a wear-reducing shaft for a planetary transmission, comprising a shaft receptacle for the mounting of the shaft, wherein the shaft is produced by at least one of the following steps: providing a basic shape of a preferably integral basic body of the shaft in particular by laser overlay welding or subsequently to processing of at least one plain bearing portion of the shaft in particular in/by means of the same laser installation, introducing at least one structured surface, which is designed for force-locking support against axial relative movement, in at least one axial portion of the shaft by laser structuring, in particular according to at least one of the following laser structuring measures, in particular depending on at least one predefined/predefinable specific elevation parameter and/or density parameter: laser structuring of a first axial surface portion, in particular over the full surface area of the shaft, laser structuring of at least two axial surface portions, in particular with a variation in the orientation of the structure in at least two spatial directions, laser structuring with an axially and/or rotationally moving shaft, laser structuring with a fixed shaft; wherein the shaft is in particular produced by a method previously described further above and in particular is configured according to the features of a/the shaft previously described further above. This allows aforementioned advantages to be realized, especially also with regard to the efficient provision of the shafts while still having a high degree of individualization of a particular configuration of the shaft(s).

The aforementioned object is also achieved by the use of a multiplicity of wear-reducing shafts in a planetary transmission having at least one planetary transmission stage in a shaft receptacle of a planet carrier for the mounting of the shafts, wherein the respective shaft comes into contact with at least one outer shell surface portion, which is designed for force-locking, preferably with two outer shell surface portions on both sides of a plain bearing surface, with a force-lockingly acting laser-structured force-locking structure in a manner force-lockingly contacting the shaft receptacle directly on the shell surface without positive-locking contours in the shaft receptacle in such a way that a coefficient of friction (or static coefficient of friction) greater than 0.5 is ensured, in particular by the respective shaft and the shaft receptacle forming a fit with a predefinable normal force, in particular use of the multiplicity of wear-reducing shafts for already existing and installed transmissions/transmission components, in particular corresponding use of shafts previously described further above. This enables the aforementioned advantages to be realized, especially also with regard to efficient/effective functional integration in the shaft for a long-lasting, robust operation even under high dynamic loads.

The aforementioned object is also achieved by the use of at least one wear-reducing shaft in an industrial transmission, in a shaft receptacle for the mounting of the shaft, in particular in each case as planetary shafts in a planet carrier of a planetary transmission, wherein the shaft on an outer shell surface, which is provided for force-locking, has a force-lockingly acting laser-structured structure in each of two outer shell surface portions which are arranged force-lockingly/frictionally in the shaft receptacle, wherein a first structure/laser structure is introduced in the first outer shell surface portion and a second structure/laser structure is introduced in the further outer shell surface portion, wherein the first and second structures/laser structures have different (shaping) parameters or differ structurally from each other, wherein the shaft is preferably introduced thermally into the shaft receptacle, in particular with the shaft also comprising at least one plain bearing surface for a planetary gear, in particular corresponding use of shafts previously described further above. This allows the aforementioned advantages to be realized, especially with regard to a highly specifically optimized force-locking connection at the respective contact/bearing point without the need for additional positive locking.

Summary: The present invention relates to an industrial transmission, comprising at least one shaft and at least one shaft receptacle for the fixed/axially fixed mounting of the shaft, wherein the shaft is mounted in at least one axial portion in the shaft receptacle; wherein the shaft is provided with at least one wear-reducing surface and is mounted in the shaft receptacle by means of at least one laser-structured surface portion force-lockingly/frictionally against axial displacement, in particular with the industrial transmission in the form of a planetary transmission or comprising at least one planetary transmission stage. Furthermore, the present invention also relates to wear-reducing shafts with at least one laser-structured surface portion for such industrial transmissions. The present invention also relates to corresponding methods and uses.

### BRIEF DESCRIPTION OF THE FIGURES

In the following figures of the drawing, the invention is described in more detail by way of preferred exemplary embodiments, wherein the features shown below can represent an aspect of the invention both individually and in combination, and wherein for reference signs which are not explicitly described in a particular figure of the drawing reference is made to the other figures of the drawing. In the figures, in each case in a schematic representation:

FIG. 1 shows a sectioned side view of components of a planetary transmission according to one exemplary embodiment;

FIG. 2 shows a detailed perspective view of a wear-reducing shaft for use in a planetary transmission according to exemplary embodiments;

FIG. 3 shows individual steps of a method for producing a wear-reducing shaft according to exemplary embodiments.

### DETAILED DESCRIPTION OF THE FIGURES

The invention is first explained with general reference to all the reference numbers and figures. Special features or individual aspects or aspects of the present invention that are clearly visible/representable in the respective figure are addressed individually in conjunction with the respective figure.

A planetary transmission 100 is provided comprising at least one shaft 101 (in particular planetary shaft) which is axially fixedly mounted in a shaft receptacle 103 (e.g. cast bore in planet carrier, planet carrier bore) in the axial direction (x) with laser structuring 10, which is provided, for example, in two axial portions X1, X2 of the shaft, in particular at the respective shaft end.

The structuring/laser structuring 10 comprises at least one (laser-)structured surface (portion) 10.1 on at least one outer shell surface of the shaft (the shaft can optionally have different diameters on different axial portions and thus can also have a plurality of outer shell surfaces). Preferably, both a first and a second force-lockingly effective outer shell surface portion 10.1a, 10.1b are provided, wherein the structure/laser structure can also be individually configured in each case.

By means of the laser structure contact surface(s), in particular in conjunction with a comparatively high normal force Fn, an axially fixed force-locking (in particular exclusively force-locking/statically frictional) connection can be provided without the requirement of positive locking between shaft and shaft receptacle, in particular in the case of advantageously robust constant mode of action over a long operating period. The normal force Fn acts in the structured surface portion and is substantially oriented in the radial direction (r) and can be comparatively precisely predefined, for example, by a certain method of installation and/or by a certain fit and can be individually optimized for the respective application and the material selected (material pairing of shaft and shaft receptacle).

The planetary transmission 100 comprises at least one planet carrier 105, on which the respective shaft receptacle 103 is formed, wherein the planetary gears 107 guided circumferentially in a planetary ring gear 109 are mounted around the shafts 101 by means of the planet carrier 105.

In a configuration as a planetary transmission (or comprising at least one planetary transmission stage), the shafts preferably each have at least one plain bearing portion 101.1 arranged between or next to the laser-structured surface(s). For this purpose, a plain bearing portion X3 (further axial portion) can be provided on the respective shaft.

The respective shaft can also be characterized by individual steps of a production method, in particular: step S1 providing a basic shape or a basic body of the shaft (wherein this step may also include the definition of the geometric basic shape and/or a material selection and optionally also tempering or hardening the material or individual surface coatings or layers); step S2 laser (overlay) welding of the shaft and/or forming at least one plain bearing portion on the shaft; step S3 introducing at least one force-lockingly acting surface structure on the shaft by means of/by laser structuring, in particular in conjunction in terms of manufacturing with step S2; step S4 installing the shaft, for example by using a thermal process or compression or the like. It has been shown that steps S2 and S3 can be advantageously integrated together in a joint manufacturing process on a laser Installation 200 with a laser welding device.

In the following, special features of the invention are explained with reference to individual figures or exemplary embodiments.

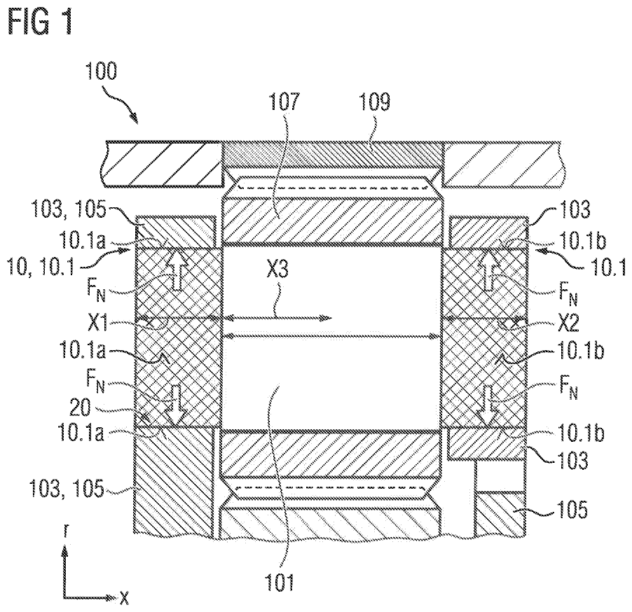

FIG. 1 shows an exemplary application/use of the shaft 101 according to the invention, with reference to a planet carrier 105 with a shaft receptacle 103 and planetary shafts 101 mounted thereon in each case in an axially fixed manner in one or two axial portions. The respective planet gear 107 is held at a predefined axial position by means of the planet carrier 105 and guided circumferentially in the planetary ring gear 109. The following figures show different exemplary embodiments, which can also be implemented, for example, in a transmission or an Installation situation as shown in FIG. 1, optionally at one or both shaft ends (axial portions) or contact regions between shaft and shaft receptacle. As already explained further above, the installation situation can optionally also be selected differently, for example at a different location or at another shaft or in a different type of transmission.

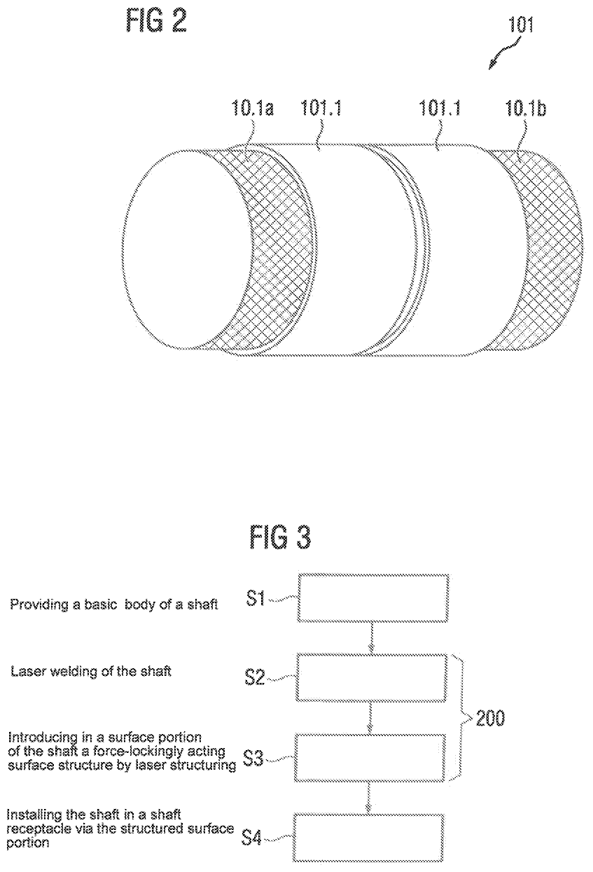

FIG. 2 shows a shaft 101 with force-lockingly acting laser structured surfaces 10.1a, 10.1b in two axial portions corresponding to the contact regions for the shaft receptacle. Plain bearing portions 101.1 (or a single plain bearing portion) are provided between the laser-structured surfaces.

The laser structuring step can be additionally combined with a process step relating to laser overlay welding on the same installation. By means of a laser welding installation, the surface structure of the cylindrical (or conical) contact regions of shaft and shaft receptacle (Le. the shaft fixings) can be provided by laser structuring (without supply of material, without supply of welding material) in such a way that coefficients of friction of >0.5 are permanently ensured.

The invention is also based on the concept of being able to minimize the axial movement in the shaft contact by carrying the shaft(s) and also by increasing the torsional stiffness; in this respect, an/the unwanted relative movement of the respective shafts, particularly with regard to cyclic axial migration in and out, can be noticeably prevented owing to the laser structured surface(s). By means of the (non-wearing) (laser) structure in conjunction with as tight a fit as possible, it is also possible to create a mounting or contacting or connection that may also be described by the term “bonded” (mounting or direct contacting of shaft and shaft receptacle). For example, a (comparatively high) coefficient of friction that can be used/is relevant to practice for the design of the Industrial transmission or at least other directly affected machine/transmission elements is set at 0.8. A person skilled in the art may, depending on design details and the number and strength of the respective shaft(s), set an appropriate (theoretical) coefficient of friction for the design.

FIG. 3 schematically indicates individual steps of a production method of a shaft described here, namely: step S1 providing a basic shape or a basic body of the shaft; step S2 laser (overlay) welding of the shaft and/or forming at least one plain bearing portion on the shaft; step S3 introducing at least one force-lockingly active surface structure on the shaft by means of/by laser structuring; step S4 installing the shaft. Steps S2 and S3 can optionally be carried out together in an Integrated process on a laser installation 200 with a laser welding device (or a corresponding manufacturing line). The production method can optionally comprise steps S1 to S3 or all of steps S1 to S4, depending on whether the production/provision relates only to the individual shafts 101 or to the entire corresponding industrial transmission 100.

### LIST OF REFERENCE SIGNS

10 laser structuring
10.1 laser-structured surface (portion) on outer shell surface
10.1a first force-lockingly effective outer shell surface portion
10.1b second/further force-lockingly effective outer shell surface portion
20 axially fixed, force-locking connection between shaft and shaft receptacle
100 Industrial transmission
101 shaft, in particular planetary shaft
101.1 plain bearing portion or bearing surface for planetary gear
103 shaft receptacle, e.g. cast bore, in particular planet carrier bore
105 planet carrier
107 planet or planet gear
109 planetary ring gear with internal toothing
200 laser installation with laser welding device
FN normal force in the structured surface portion
S1 providing a basic shape or a basic body of the respective shaft
S2 laser (overlay) welding and/or forming at least one plain bearing portion
S3 introducing a force-lockingly acting structure by means of/by laser structuring
S4 installing the shaft
X1 first axial portion
X2 second axial portion
X3 plain bearing portion (further axial portion)
X axial direction
r radial direction

What is claimed is:

1.-15. (canceled)

16. A planetary transmission, comprising:
a shaft; and
a shaft receptacle designed to fixedly mount the shaft in an axial portion in the shaft receptacle;
wherein the shaft is mounted in the shaft receptacle via a structured surface portion in a force-locking or frictional manner so as to restrain the shaft against displacement in an axial direction, and
wherein the shaft and the shaft receptacle are direct contact partners.

17. The planetary transmission of claim 16, further comprising a planetary gear, said shaft being a shaft of the planetary gear.

18. The planetary transmission of claim 16, wherein the structured surface portion is a laser-structured surface portion.

19. The planetary transmission of claim 16, wherein the shaft includes a cylindrical surface portion with a force-lockingly acting structured outer shell surface portion, which comes to bear purely force-lockingly in the shaft receptacle so that a normal force acting in the cylindrical surface portion reduces a relative movement between the shaft and the shaft receptacle.

20. The planetary transmission of claim 16, wherein the structured surface portion for force-locking support in the axial direction includes an axial portion with a coefficient of static friction of at least 0.5.

21. The planetary transmission of claim 16, wherein the structured surface portion varies over a circumference.

22. The planetary transmission of claim 16, further comprising a gear mounted around the shaft and having a side on which the structured surface portion is provided, or wherein the structured surface portion is formed on both sides of the gear.

23. The planetary transmission of claim 16, wherein the structured surface portion includes a structure which is interrupted in individual segments of the structured surface portion.

24. The planetary transmission of claim 16, wherein the shaft includes a surface portion within which a linear density or direction of a structure or an intensity and shape of the structure is realized such as to ensure a coefficient of static friction of at least 0.5 in the axial direction over the structured surface portion.

25. The planetary transmission of claim 16, further comprising a planet carrier, said shaft receptacle being provided in a planet carrier bore of the planet carrier, with the shaft representing a planetary shaft which is arranged on the planet carrier in a positive-locking manner against a relative movement.

26. The planetary transmission of claim 16, designed for installation in a drive train of a wind turbine.

27. The planetary transmission of claim 16, wherein the shaft is mounted in two axial portions in the shaft receptacle with cylindrical or conical contact surfaces, with the structured surface in the two axial portions having a same or a different configuration; or wherein the shaft is mounted in two axial portions in the shaft receptacle with a cylindrical contact surface and with a conical contact surface, respectively, wherein the structured surface in the two axial portions has a different configuration.

28. A method, comprising introducing in a basic body a structured surface in an axial surface portion of the basic body to produce a wear-reducing shaft for use in a planetary transmission and installation in a shaft receptacle such as to realize a force-locking support of the shaft in the shaft receptacle so as to restrain the shaft against displacement in an axial direction.

29. The method of claim 28, further comprising installing the shaft in a planet carrier of a planetary transmission.

30. The method of claim 28, further comprising:
introducing a substantially force-lockingly acting surface in the axial surface portion of the shaft by a laser-structuring measure selected from the group consisting of:
the structured surface is a laser-structured surface which is generated in a wavy or serpentine structure or in an imbricated structure,
laser structuring of a first axial surface portion,
laser structuring of at least two axial surface portions with variation in orientation of the structure in at least two spatial directions,
laser structuring with an axially and/or rotationally moving shaft, and
laser structuring with a fixed shaft.

31. The method of claim 30, wherein generating the laser-structured surface in the wavy or serpentine structure or in the imbricated structure depends on a predefined/predefinable specific elevation parameter and/or density parameter.

32. The method of claim 28, wherein the structured surface is applied by laser in each of two outer shell surface portions of the base body such that a first laser structure is introduced in one of the two outer shell surface portions and a second laser structure is introduced in another one of the two outer shell surface portion, with the first and second laser structures having different parameters, and with the outer shell surface portions being arranged in a force-locking or frictional manner in the shaft receptacle.

33. The method of claim 32, further comprising introducing the shaft thermally into the shaft receptacle.

34. The method of claim 32, further comprising forming the shaft with a plain bearing surface for a planetary gear of the planetary transmission, with the two outer shell surface portions being provided on both sides of the plain bearing surface.
